(19) United States
(12) Patent Application Publication
(10) Pub. No.: US 2007/0002868 A1
(43) Pub. Date: Jan. 4, 2007

(54) Location based quality of service (QoS) control

(76) Inventors: Haibo Qian, Plano, TX (US); Alex Chin, Plano, TX (US)

Correspondence Address: GARLICK HARRISON & MARKISON, P.O. BOX 160727, AUSTIN, TX, 78716-0727, US

(21) Appl. No.: 11/170,503

(22) Filed: Jun. 29, 2005

(51) Int. Cl. H04Q 7/00

(52) U.S. Cl. 370/395.21

(57) ABSTRACT

A location based Quality of Service (QoS) is negotiated for each mobile terminal entering a mobile network. Each mobile terminal receives a routing area identification that identifies the mobile terminal's location. The routing area identification and International Mobile Subscriber Identity (IMSI) are transmitted to a QoS selection block within a QoS network element to map the mobile terminal to a QoS group and a corresponding QoS profile. The QoS selection block provides a selected QoS based on the QoS profile to the network element wherein the selected QoS rating is negotiated with the mobile terminal. The QoS negotiation includes using the selected QoS rating when the mobile terminal routing area maps to one of the corresponding QoS groups or using a subscribed QoS rating received from the roaming mobile terminal HLR when the mobile terminal routing area and IMSI do not map to one of the corresponding QoS groups.

### BACKGROUND OF THE INVENTION

1. Technical Field of the Invention

This invention relates generally to wireless communication systems and, more particularly, to the quality of service provisioning in a wireless network.

2. Description of Related Art

A General Packet Radio Service (GPRS) is a non-voice value added service that allows information to be sent and received across a mobile telephone network. It supplements, or rides on top of, today's circuit switched data and short message service networks providing more efficient packet-based data and short message service networks. The theoretical maximum speed of GPRS includes speeds of up to approximately 171.2 kilobits per second (kbps). This maximum speed is achievable in GPRS systems using all eight timeslots at the same time in a Time Division Multiple Access (TDMA) context.

This speed is about three times as fast as data transmission speeds possible over today's fixed telecommunication networks and ten times as fast as current circuit switched data services on Global System for Mobile Communications (GSM) standard TDMA networks. Thus, GPRS systems are advantageous in that they require less system resources to transmit a fixed amount of data in comparison to a traditional circuit switched data network or other network type. By allowing information to be transmitted more quickly and efficiently across the mobile network, GPRS may well be relatively less costly compared to Short Message Service (SMS) and circuit switched mobile data services.

GPRS also facilitates instant connections in which information can be sent or received immediately as the need arises, subject to radio coverage. No dial up modem connection is necessary. GPRS, similar to some broadband connections for personal computers, often is referred to as being “always connected”. Thus, another one of the advantages of GPRS is that data may be transmitted immediately, whenever the need arises if a connection has previously been initiated. In contrast to circuit switched data networks in which a connection must be established to transmit a data packet or data file, GPRS operation is extremely efficient in those situations in which a small amount of data is to be sent. As the emphasis of many designs today are to create wireless computer networks and to connect data devices including personal computers to wireless transceivers and mobile terminals, a system that provides instantaneous response such as GPRS is very important for time critical applications, and, more generally, for the implementation of wireless computer networks. For example, a remote credit card authorization system implemented in a wireless network can be greatly improved if it is unnecessary for the customer to wait the amount of time that is required to establish a connection.

As suggested before, GPRS involves overlaying a packet based air interface on an existing circuit switched wireless network. For example, the circuit switched wireless network may comprise a GSM network. Accordingly, the user is given an option to utilize a packet based data service. In order to overlay a packet based air interface over a circuit switched network, the GPRS standard defines new infrastructure nodes to minimize the impact to existing networks in terms of hardware and software. For example, a gateway GPRS service node (GGSN) and a serving GPRS support node (SGSN) are two such infrastructure nodes.

Another advantage of GPRS is that the packet switching that results from the infrastructure nodes allows the use of GPRS radio resources only when users actually are sending or receiving data. Unlike traditional circuit switched voice networks, a connection is not continuously reserved for a user for the intermittent transmission of data. This efficient use of scarce radio resources means that larger numbers of GPRS users can share the same bandwidth and be served from a single base station or cell. The actual number of users that may use the system at one time depends, of course, on the amount of data being transferred.

GPRS and a similar and newer technology known as the Universal Mobile Telecommunications System (UMTS) use a packet-mode technique to transfer high speed and low speed data and signaling in an efficient manner to optimize network and radio resources. Strict separation between the radio subsystems and network subsystems is maintained thereby allowing a network subsystem to be reused with other radio technologies. A common packet domain core network is used for both GSM and UMTS. The common core network provides packet switch services and supports differing Quality of Service (QoS) levels to allow efficient transfer of non-continuous bit rate traffic (for example, bursty data transfers).

The UMTS network also provides connectionless services. Moreover, GPRS and UMTS support push services. A push service is the delivery of data or multimedia information from a network node to user equipment for the purpose of providing subscriber based information from the network. A push service also can include activating a Packet Data Protocol (PDP) context, if necessary. Examples of delivery networks that offer push services include, as stated, the GPRS network, but can also include other equipment, such as a session initiation protocol (SIP) proxy, a push proxy or an SMS service center. Push services are becoming popular because of their ability to deliver advertisements, as well as subscriber ordered content services such as streaming media, web pages, traffic conditions, sports scores, stock quotes, etc. New services and features being offered require that push capabilities be implemented to enable external Internet protocol networks to deliver data to third generation (3G) wireless terminals in the paging system (PS) domain.

Some of these new services and features provided by network service providers are negotiated with the mobile terminal during authentication and may be limited subject to network congestion and available bandwidth. From the perspective of a service provider, the congestion impacts the quality of service that is provided to its subscribers and potentially impacts its ability to provide higher Quality of Service (QoS) for in-network mobile terminals. There is a need, therefore, for a system and method that provides for selective and localized QoS assignment while providing enhanced network QoS control during periods of high network usage and congestion.

### BRIEF SUMMARY OF THE INVENTION

To meets these needs and others, an apparatus and a method of the present invention determines a Quality of Service (QoS) rating for a GPRS/UMTS mobile terminal to provide improved allocation of network resources to selective mobiles based on current location of the mobile terminal during periods of high usage and congestion. In a GPRS/UMTS network, a SGSN provides a QoS negotiation between the mobile terminal and the network that is based upon a subscribed QoS rating and a requested QoS. Typically, the subscribed QoS is a maximum QoS that may be assigned though a lower QoS may be assigned if the mobile requests a QoS that is less than the subscribed QoS level.

In the described embodiments of the invention, however, the network element (e.g., SGSN) determines a negotiated QoS rating that is based upon a mobile terminal's current location, i.e., routing area and its International Mobile Subscriber Identity (IMSI) to provide the negotiated QoS rating that is selective and differentiated. As a part of determining the negotiated QoS, the SGSN evaluates network capabilities in relation to subscribed services for the mobile terminal. If the mobile terminal routing area and IMSI do not map to a QoS group in the specified table, the network element (e.g., SGSN) uses a subscribed QoS rating in a subscribed QoS profile received as a maximum QoS for the roaming mobile terminal Home Location Register (HLR) in one embodiment of the invention. The invention takes advantage of the mobility management capability of the network element (e.g., SGSN) to adjust the QoS rating of the mobile terminal as it roams from one routing area to another.

Upon entering a network, each mobile terminal receives a routing area identification that identifies where the mobile terminal is currently located. This routing area identification may be used to identify whether the mobile terminal is presently located in a routing area experiencing congestion. A network controller is operable to assign QoS ratings in this congested routing area based upon the routing area identification and the IMSI. The routing area identification and the IMSI are transmitted to a QoS network element having a QoS Selection block that is operable to map the mobile terminal to a mobile terminal QoS group, defined by a range of IMSI values, to a QoS mapping table based on the routing area identification and the IMSI. Thereafter, the network controller or QoS network element of the embodiments of the present invention determines a corresponding QoS profile based on the QoS group and sends a negotiated QoS rating based on the determined QoS profile.

The negotiated QoS ratings are based on a desired network routing area condition that includes routing area congestion and available bandwidth in relation to the mapping table entry in one embodiment. When there is no mapping table entry, a default QoS group having a default QoS profile becomes the selected QoS profile. In this case, the QoS network element negotiates the QoS rating and uses the default profile, which is typically set to the subscribed QoS profile received from a roaming mobile terminal Home Location Register (HLR), which may include QoS parameters not supported by a visited network. When using the default QoS profile, the present invention selects a plurality of fields in the subscribed QoS profile received from the roaming mobile terminal HLR and overrides the plurality of selected fields with corresponding fields from the default profile provided by the QoS selection block. The selected fields includes at least one of a traffic class, a maximum uplink bandwidth field, a maximum downlink bandwidth field, and a traffic handling priority field.

The above-referenced description of the summary of the invention captures some, but not all, of the various aspects of the present invention. The claims are directed to some of the various other embodiments of the subject matter towards which the present invention is directed. In addition, other aspects, advantages, and novel features of the invention will become apparent from the following detailed description of the invention when considered in conjunction with the accompanying drawings.

### BRIEF DESCRIPTION OF THE SEVERAL VIEWS OF THE DRAWINGS

FIG. 1 is a functional block diagram of a communication network formed according to one embodiment of the present invention;

FIG. 2 is a functional block diagram of location based QoS control according to the present invention;

FIG. 3 is a functional block diagram of a QoS Selection Block in accordance with the present invention;

FIG. 4 is a location based QoS control data signal graph according to the present invention; and

FIG. 5 is a flow chart of a method for providing location based QoS control according to the present invention.

### DETAILED DESCRIPTION OF THE INVENTION

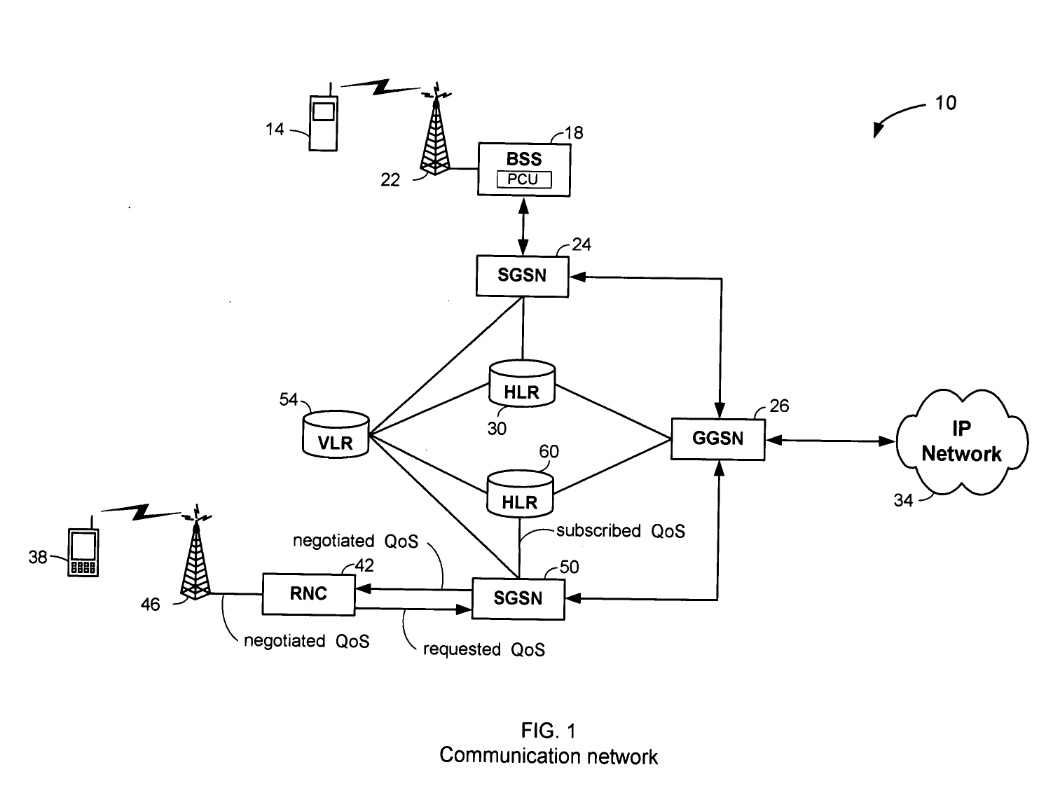

FIG. 1 is a functional block diagram of a communication network formed according to one embodiment of the present invention. The communication network shown generally at 10 includes a mobile terminal 14 that communicates within a GPRS/UMTS network. Mobile terminal 14 is a GPRS-capable and may also be voice-capable mobile terminal that communicates with the GPRS/UMTS network by way of base station system (BSS) 18 and tower 22. The BSS 18 includes a packet control unit (PCU) that separates the packet data for transmission to a serving GPRS support node (SGSN) by way of the Gb interface. Although shown as part of BSS 18, the PCU could be formed as a separate unit. The GPRS network includes SGSN 24 that is operably coupled to a gateway GPRS support node (GGSN) 26.

Additionally, a Home Location Register (HLR) 30, containing subscriber profile information for both GSM and UMTS networks, is operably coupled to provide the subscriber profile information to SGSN 24. The SGSN, such as SGSN 24, is for communicating with a mobile terminal to initiate a data session or connection through a wireless data packet network and providing data packet routing between the mobile terminal and the GGSN. The GGSN, such as GGSN 26, provides a gateway, as its name suggests, from the wireless data packet network to a traditional data packet network such as IP network 34. Thus, as may be seen, GGSN 26 is operably coupled to IP network 34. A roaming mobile terminal 38 communicates, by way of radio network controller (RNC) 42 and tower 46, with SGSN 50 within a UMTS network. The SGSN 50 connects to GGSN 26 to access IP network 34. A Visitor Location Register (VLR) 54 provides roaming mobile terminal 38 information received from the roaming mobile terminal's HLR 60. In addition to providing authentication for mobile terminal 38, HLR 60 provides the subscriber profile that includes a subscribed Quality of Service (QoS) rating.

Generally, the SGSN Monitors an individual mobile terminal location and performs related functions such as access control and mobility management. The SGSN connects to the GSM base station through the high-speed frame relay Gb interface and/or to the UMTS RNC through the Iu interface. The SGSN is functionally equivalent to a mobile switching center (MSC) in a voice-only GSM network. The GGSN provides inter-working with external packet switched networks that are connected to SGSNs via an IP-based packet domain backbone network. Generally, the GGSN provides an interface between the GPRS/UMTS networks and an external packet switched network such as the Internet.

In a mobile network, the network operator regulates call admission and call regulation to maintain an acceptable QoS. Previously, the control of the QoS rating of a mobile terminal was strictly based on what is requested by the mobile and by a mobile terminal's subscribed QoS as defined in the mobile terminal's HLR. Thus, when roaming mobile terminal 38 requests a specific QoS rating, the network element authorizes the QoS rating based on the subscribed QoS rating provided from the roaming mobile terminal's HLR.

The method and the apparatus of the present invention includes a QoS selection block within a QoS network element including at least one of a GGSN, SGSN, and RNC or BSS to provide location based QoS control. QoS selection logic within the QoS selection block operates to select one of a plurality of QoS profiles having a plurality of QoS ratings and to operably couple the selected QoS rating to the QoS network element. By differentiating QoS ratings based on a mobile terminal's current location and identification, the QoS network element provides a more granular level of QoS control. According to this method, the routing area identification, which determines the current service location of the mobile terminal, acts as a parameter in determining the QoS rating. Additionally, mobile terminals are classified into different mobile terminal QoS groups based on their International Mobile Station Identity (IMSI) and their routing area identification.

In each routing area, the different mobile groups are associated with different QoS profiles. When a mobile terminal requests a QoS rating, the QoS selection block within the QoS network element, SGSN 50 for example, compares the mobile terminal routing area and IMSI and provides a selected QoS rating based on that comparison and the requested QoS rating wherein the negotiated QoS rating is limited by the lower of the requested QoS rating and the QoS rating determined within a mapping table evaluated by the QoS selection block. More specifically, if the mobile terminal belongs to one of the defined mobile terminal QoS groups then the corresponding QoS rating in the QoS profile is provided as the selected QoS rating unless the requested QoS is lower. If, however, the mobile terminal does not belong to a defined group, then the subscribed QoS rating in the subscribed QoS profile received from HLR 60 is used as a maximum negotiated QoS rating. Moreover, the QoS selection block is invoked as the network element detects that the mobile terminal is roaming into a new routing area. If, the selected QoS rating based on the new routing area identification as well as the mobile terminal's IMSI is different from the QoS negotiated in the previous routing area, the network element notifies the mobile terminal of the new negotiated QoS rating.

Negotiating the QoS rating based on different QoS profiles allows the network operator more flexibility in controlling QoS by location. For example, in heavily congested areas, the network operator has the flexibility to limit the QoS rating to roaming mobile terminals in order to give local mobile terminals priority to subscribed QoS levels.

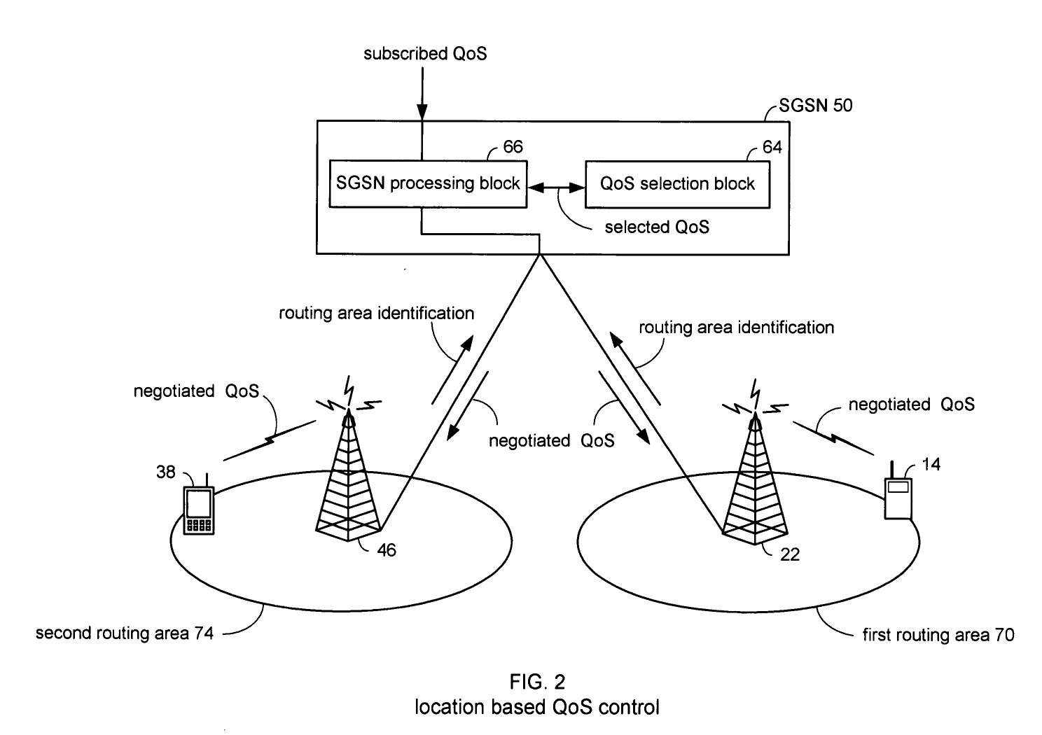

FIG. 2 is a functional block diagram of location based QoS control according to the present invention. As can be seen in FIG. 2, a first routing area 70 and a second routing area 74 have been defined by the network operator. QoS selection block 64 and SGSN processing block 66 are processing blocks internal to QoS network element SGSN 50. Mobile terminal 14 is operating in its home network and will receive a QoS rating based on the subscribed QoS rating maintained in the mobile terminal's profile and based on defined QoS profiles for mobile terminal QoS groups operating in the first routing area. If, due to congestion for example, mobile terminals operating in first routing area 70 are assigned QoS profiles then QoS selection block 64 will provide the selected QoS rating, based on the assigned QoS profile, to SGSN processing block 66. The SGSN 50 is operable to provide the negotiated QoS rating to the mobile terminal based on the selected QoS rating.

Similarly, roaming mobile terminal 38 will request a QoS rating from SGSN 50. Based on the routing area identification of second routing area 74, SGSN 50 first determines if mobile terminal 38 belongs to one of the defined mobile terminal QoS group then selects the QoS rating based on the QoS profile for the defined mobile terminal QoS group. If, however, mobile terminal 38 does not belong to one of the defined mobile terminal QoS groups, SGSN 50 will provide the negotiated QoS rating based on the mobile terminal's subscribed QoS rating in the subscribed QoS profile received from its HLR.

Another aspect of the embodiments of the present invention is to assign a default profile for each routing area. If a roaming mobile terminal does not belong to one of the defined mobile terminal QoS groups and the subscribed QoS profile contains parameters that are not supported by the network operator in the routing area, QoS selection block 64 returns the selected QoS rating for the default QoS profile. This assures the network operator can control the QoS ratings for roaming mobile terminals and limit the QoS rating of roaming mobile terminals according to network capabilities. One benefit of this is that the network operators' mobile terminals may be given priority over visiting mobile terminals.

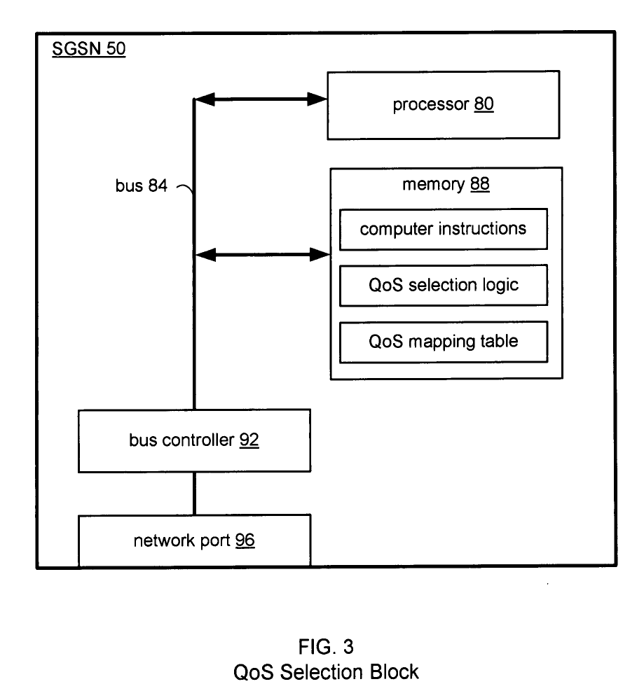

FIG. 3 is a functional block diagram of an SGSN in accordance with the present invention. SGSN 50 includes a processor 80 that is coupled to communicate over a bus 84. A memory 88 further is coupled to bus 84 and is for storing computer instructions that define the operational logic of SGSN 50. Bus 84 is coupled to a bus controller 92, which controls the communications and timing of communications thereon. Bus controller 92 is operably coupled to a network port 96 for receiving communications from external networks elements In operation, processor 80 communicates with memory 88 by way of bus 84 to retrieve computer instructions stored therein and to execute the computer instructions to operate according to the logic defined within the computer instructions of memory 88. Memory 88 specifically includes computer instructions defining QoS selection logic and a QoS mapping table that associates the mobile terminal IMSI with a mobile terminal QoS group and a corresponding QoS profile. Additionally, computer instructions stored in memory 88 define logic for assigning a default QoS profile having a default QoS rating when the mobile terminal does not belong to one of the defined QoS groups.

Thus, when SGSN 50 receives the IMSI and the routing area identification from the mobile terminal by way of the RNC (RNC 42 of FIG. 1), computer instructions stored in memory 88 include logic to prompt the QoS selection logic to provide a QoS rating specified within the QoS mapping table when the mobile terminal routing area and IMSI maps to a defined QoS group and to provide a subscribed QoS rating received from a roaming mobile terminal's HLR when the mobile terminal routing area and IMSI do not map to a QoS group within the mapping table.

For this example, it is assumed that the QoS rating found in the QoS mapping table and the subscribed QoS value are equal to or lower than a requested QoS from the mobile terminal. The memory further includes computer instructions that define logic to negotiate the QoS rating using a default profile when a subscribed QoS profile received from the roaming mobile terminal's HLR includes QoS parameters not supported by the SGSN. Computer instructions stored in memory 88 define logic for processor 80 to transmit the negotiated QoS rating to an external network element, such as RNC 42 of FIG. 1, by way of bus controller 92 and network port 96.

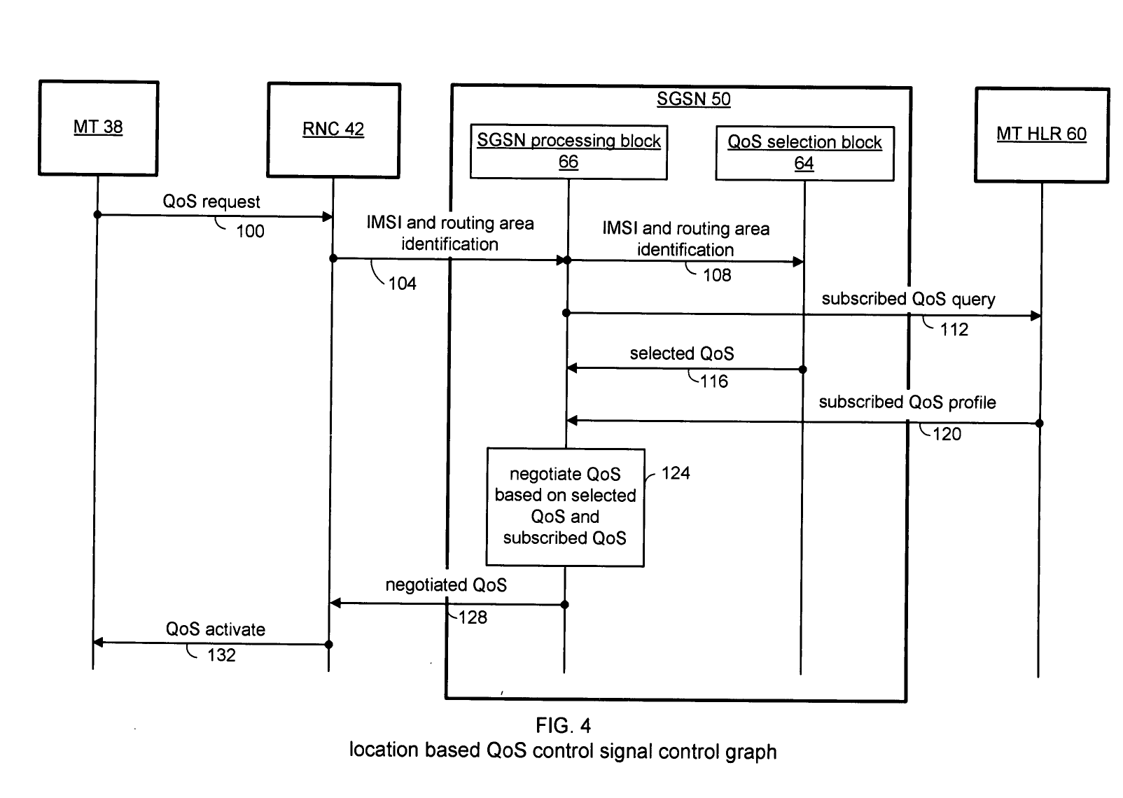

FIG. 4 is a location based QoS control data signal graph according to the present invention. When mobile terminal (MT) 38 enters a routing area served by RNC 42 and SGSN 50, MT 38 sends a QoS request (signal 100) in order to receive a QoS rating. The MT 38 may be a subscriber to the controlling network operator or may be a roaming mobile terminal. In either case, the QoS rating must be negotiated so that network resources are not overloaded. In the case of the roaming mobile terminal, the request must be forwarded to the HLR of the roaming mobile terminal. RNC 42 forwards the routing area identification assigned to MT 38 during authentication as well as the IMSI and routing area identification (signal 104) to the SGSN processing block 66 internal to SGSN 50. SGSN processing block 66 then forwards the IMSI and routing area identification (signal 108) to QoS selection block 64. At the same time, SGSN processing block 66 sends a subscribed QoS query (signal 112) to MT HLR 60. Based on the IMSI and the routing area identification, MT 38 is assigned to a mobile terminal QoS group having a corresponding QoS profile. The QoS profiles are assigned based on the routing area and a range of IMSIs so that routing area congestion and available bandwidth, among others, is kept within pre-determined limits.

QoS selection block 64 maps the received routing area identification and IMSI to the range of values assigned to each of the mobile terminal groups. If the mapping succeeds, QoS selection block 64 returns a selected QoS rating to SGSN processing block 66 (signal 116) based on the QoS profile defined for the particular mobile terminal group. If MT 38 does not map to a QoS profile, QoS selection block 64 returns a selected QoS rating based on a default profile. SGSN processing block 66 also receives a subscribed QoS profile (signal 120) from MT HLR 60. Since MT 38 may belong to a network serviced by a different operator, the subscribed QoS profile may include QoS parameters that are not supported by SGSN 50.

Once SGSN processing block 66 has received the selected QoS and the subscribed QoS, it will determine the negotiated QoS rating based on the selected QoS and the subscribed QoS (step 124). The negotiated QoS rating will override the subscribed QoS unless MT 38 does not belong to a defined mobile terminal group. In that case, the subscribed QoS will be used unless it contains parameters not supported by the network operator, in which case the default QoS profile is used to override selected fields within the subscribed QoS profile. The negotiated QoS (signal 128) rating is forwarded to RNC 42 which, then sends a QoS activate (signal 132) to MT 38.

Although the preceding discussion has focused on the SGSN as the negotiating function, one of average skill in the art should realize that SGSN processing block 66 and QoS selection block 64 can readily be formed to function within the GGSN or the RNC.

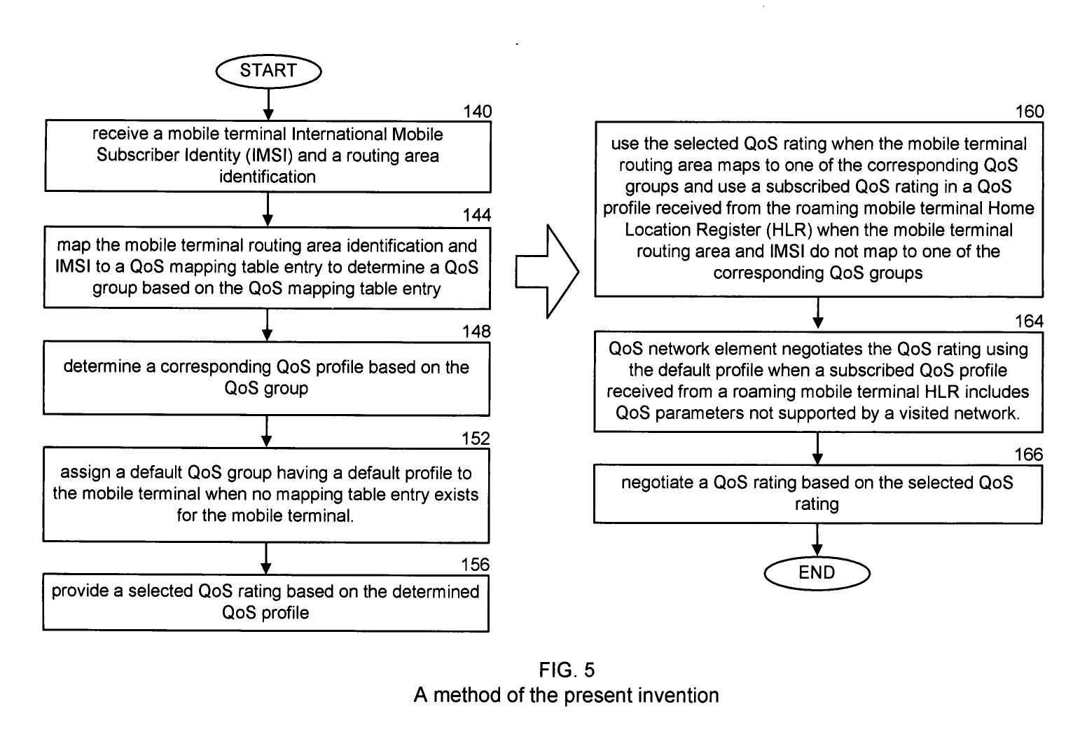

FIG. 5 is a flow chart of a method in a QoS network element for determining a Quality of Service (QoS) rating for a GPRS/UMTS mobile terminal in accordance with the present invention. First, the method receives a mobile terminal International Mobile Subscriber Identity (IMSI) and a routing area identification (step 140) in a QoS network element comprising one of a GGSN, a SGSN, and an RNC. The IMSI is a unique 15 digit (maximum) identifier allocated to each mobile terminal in a GPRS/UMTS network. It comprises a Mobile Country code (MCC), a Mobile Network Code (MNC), and a Mobile Station Identification Number (MSIN). Once the IMSI and the routing area identification are received, the QoS network element sends the information to an internal QoS selection block wherein the QoS selection block maps the mobile terminal routing area identification and IMSI to a QoS mapping table entry to determine a QoS group based on the QoS mapping table entry (step 144) and a corresponding QoS profile based on the QoS group (step 148). Each QoS group is assigned a range of IMSI values then each routing area is assigned to a QoS group based on a selected routing area performance.

When no mapping table entry exists, the QoS selection block assigns a default QoS group having a default QoS profile to the mobile terminal (step 152). Thereafter, the QoS selection block provides a selected QoS rating based on the determined QoS profile (step 156). It is probable that a roaming mobile terminal may have an IMSI that is not within a range included in the QoS selection block. The method then uses the selected QoS rating when the mobile terminal routing area maps to one of the corresponding QoS groups and uses the subscribed QoS rating in a subscribed QoS profile received from the roaming mobile terminal HLR when the mobile terminal routing area and IMSI do not map to one of the corresponding QoS groups (step 160).

The received subscribed QoS rating may include functions and parameters that are not supported by the QoS network element. In this case, the QoS network element negotiates the QoS rating using the default profile when a subscribed QoS profile received from a roaming mobile terminal HLR includes QoS parameters not supported by a visited network (step 164). In this case, the unsupported parameters may cause undue network interference so the method of the present invention limits the impact by substituting specific parameters from the default profile into corresponding parameters in the subscribed QoS profile and provides the substituted QoS profile as the selected QoS profile. Finally, the QoS network element negotiates a QoS rating based on the selected QoS rating (step 166).

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The invention disclosed herein is susceptible to various modifications and alternative forms. Specific embodiments therefore have been shown by way of example in the drawings and detailed description. It should be understood, however, that the drawings and detailed description thereto are not intended to limit the invention to the particular form disclosed, but on the contrary, the invention is to cover all modifications, equivalents and alternatives falling within the spirit and scope of the present invention as defined by the claims.

What is claimed is:

1. A method in a QoS network element for determining a Quality of Service (QoS) rating for a GPRS/UMTS mobile terminal, the method comprising:
receiving a mobile terminal International Mobile Subscriber Identity (IMSI) and a routing area identification;
mapping the mobile terminal routing area identification and IMSI to a QoS mapping table entry to determine a QoS group based on the QoS mapping table entry;
determining a corresponding QoS profile based on the QoS group; and
providing a selected QoS rating from a QoS selection block based on the determined QoS profile; and
determining a negotiated QoS rating based on the selected QoS rating.

2. The method of claim 1 wherein different QoS profiles are defined for each routing area based on a desired network routing area performance.

3. The method of claim 1 wherein each QoS group defines a range of IMSI values.

4. The method of claim 1 further including assigning a default QoS group having a default profile to the mobile terminal when no mapping table entry exists for the mobile terminal.

5. The method of claim 4 wherein the QoS network element determines a negotiated QoS rating using the default profile when a subscribed QoS profile received from a roaming mobile terminal Home Location Register (HLR) includes QoS parameters that are not supported by a visited network.

6. The method of claim 5 wherein determining the negotiated QoS includes:
using the selected QoS rating when the mobile terminal routing area maps to one of the corresponding QoS groups; and
using a subscribed QoS rating in a subscribed QoS profile received from the roaming mobile terminal HLR when the mobile terminal routing area and IMSI do not map to one of the corresponding QoS groups, and wherein the negotiated QoS is limited by the lower of the requested QoS rating and the selected QoS rating determined within the mapping table evaluated by the QoS selection block.

7. The method of claim 6 wherein using the subscribed QoS rating further includes:
selecting a plurality of fields in the subscribed QoS rating received from the roaming mobile terminal HLR; and
overriding the plurality of selected fields with corresponding fields from the default profile provided by the QoS selection block.

8. The method of claim 7 wherein the selected fields includes at least one of:
a traffic class;
a maximum uplink bandwidth field;
a maximum downlink bandwidth field; and
a traffic handling priority field.

9. The method of claim 8, wherein the QoS Network element is a GGSN and wherein the GGSN transmits the selected QoS rating to an SGSN.

10. The method of claim 9, wherein the QoS Network element is an SGSN and wherein the SGSN determines the negotiated QoS rating and further negotiates the QoS rating with the mobile terminal for future communications.

11. A Serving GPRS Support Node (SGSN) comprising:
a processor for executing stored computer instructions;
a bus coupled to the processor; and
a memory for storing the computer instructions that define operational logic for the SGSN, wherein the memory is coupled to the bus to enable the processor to retrieve the computer instructions, and wherein the computer instructions defines the operation of QoS selection logic for assigning a QoS profile to a GPRS/UMTS mobile terminal seeking access to a wireless packet routing network.

12. The SGSN of claim 11 wherein the QoS selection logic defines a plurality of QoS groups and a corresponding plurality of QoS profiles based on a desired network routing area performance.

13. The SGSN of claim 12 wherein the computer instructions define logic to create a QoS mapping table that maps a range of International Mobile Subscriber Identity (IMSI) values and a mobile terminal routing area identification to a selected QoS group and a corresponding QoS profile.

14. The SGSN of claim 13 wherein the computer instructions define logic to transmit the selected QoS profile to a network interface device, wherein the network interface device is one of a Gateway GPRS Support Node (GGSN) and a RNC.

15. The SGSN of claim 14 wherein the QoS selection logic includes logic to select a default QoS group having a default profile when no QoS mapping table entry exists for the mobile terminal IMSI and routing area identification.

16. The SGSN of claim 15 wherein the memory includes computer instructions that defines logic to negotiate the QoS rating using the default profile when a subscribed QoS profile received from a roaming mobile terminal Home Location Register (HLR) includes QoS parameters not supported by a visited network.

17. The SGSN of claim 16 wherein the memory includes computer instructions that defines logic to:
select a plurality of fields in the subscribed QoS rating received from the roaming mobile terminal HLR; and
override the plurality of selected fields with corresponding fields from the default profile provided by the QoS selection logic when a subscribed QoS profile received from a roaming mobile terminal Home Location Register (HLR) includes QoS parameters not supported by the visited network.

18. A Serving GPRS Support Node (SGSN), comprising:
a processor for executing stored computer instructions;
a bus coupled to the processor; and
a memory for storing the computer instructions that define operational logic for QoS selection logic, wherein the memory is coupled to the bus to enable the processor to retrieve the computer instructions, and wherein the operational logic defines the operation of the QoS selection logic for assigning QoS profiles to a GPRS/UMTS mobile terminal seeking access to a wireless packet routing network, wherein the logic for assigning the QoS profile to a GPRS/UMTS mobile terminal seeking access to a wireless packet network routing prompts the processor to:
use a selected QoS rating when a mobile terminal routing area and an International Mobile Subscriber Identity (IMSI) maps to a QoS group within a QoS mapping table; and
use a subscribed QoS rating received from a roaming mobile terminal home Location Register (HLR) when the mobile terminal routing area and the IMSI do not map to a QoS group within the mapping table.

19. The SGSN of claim 18 wherein the memory includes computer instructions that defines logic to negotiate the QoS rating using a default profile when a subscribed QoS profile received from the roaming mobile terminal HLR includes QoS parameters not supported by the SGSN.

20. The SGSN of claim 19 wherein the memory includes computer instructions that defines logic to:
select a plurality of fields in the subscribed QoS rating received from the roaming mobile terminal HLR; and
override the plurality of selected fields with corresponding fields from the default profile provided by the QoS selection logic, wherein the selected fields includes at least one of a traffic class, a maximum uplink bandwidth field, a maximum downlink bandwidth field, and a traffic handling priority field.
